(19) United States
(12) Patent Application Publication
(10) Pub. No.: US 2025/0262960 A1
(43) Pub. Date: Aug. 21, 2025

(54) CABLE GUIDE SYSTEM

(71) Applicant: Stemmann-Technik GmbH, Schüttorf (DE)

(72) Inventors: Dirk HOLKE, Bad Bentheim (DE); Martin BRINKER, Meppen (DE)

(73) Assignee: Stemmann-Technik GmbH, Schüttorf (DE)

(21) Appl. No.: 19/057,691

(22) Filed: Feb. 19, 2025

(30) Foreign Application Priority Data
Feb. 19, 2024 (DE) 102024104481.0

(51) Int. Cl. B60L 53/18; H02G 11/00

(52) U.S. Cl. CPC B60L 53/18; H02G 11/00

(57) ABSTRACT

The invention relates to a cable guiding system 1 for charging an electric vehicle, comprising a charging cable 2 with a charging plug 3 at one end, wherein the charging cable 2 is guided in a U-shape in its course from a connection end to its end with the charging plug 3 in a guiding device 4, so that the charging cable 2 in a U-shape has two legs 8, 9 next to one another or above each other, wherein the end of the charging cable 2 carrying the charging plug 3 is deflected downwards in a stationary vertical deflection station 11, so that the charging plug 3 is arranged hanging below the vertical deflection station 11, wherein the guiding device 4 has a deflection unit 16 for U-shaped deflection, which can be displaced in a longitudinal direction of the guiding device and wherein the charging cable 2 is carried and guided by several cable carriers 24 between its connecting end and the deflection unit 16, as well as between the deflection unit 16 and the vertical deflection station 11.

The invention relates to a cable guide system with the features of claim 1.

Charging cables for electric vehicles should be protected from being run over by a vehicle. The contacts of the charging plug should not be exposed to moisture. In addition, the charging plug should be easily accessible, easy to handle and, when not in use, capable to be returned to its original position safely, easily and in a space-saving manner.

The object of the invention is to provide a cable guide system that has the above-mentioned properties.

The invention achieves this object by means of a cable guide system with the features of claim 1.

The dependent claims refer to advantageous developments of the invention.

The cable guide system according to the invention is used for charging an electric vehicle and comprises a charging cable with a charging plug at one end, wherein the charging cable is guided in a horizontal U-shape in its course from a connection end to its end with the charging plug in a guiding device. The U-shaped charging cable has two legs horizontally next to one another or vertically above each other that are connected to a deflection area of the charging cable. The end of the charging cable carrying the charging plug is deflected downwards in a stationary vertical deflection station, so that the charging plug is arranged hanging below the vertical deflection station. The cable guide system according to the invention is a hanging arrangement, for example under a ceiling or a ceiling-mounted supporting structure. The cable guide system according to the invention is particularly space-saving, either in width or in height, depending on the orientation of the legs of the charging cable running next to one another. With legs running horizontally next to one another, it requires only a minimal installation height. With legs running vertically above each other, it requires only a minimal width. The charging cable is deflected by means of a deflection unit. The deflection unit can be moved in the longitudinal direction of the guiding device. Between the deflection unit and the vertical deflection station or between the deflection unit and the connection end, the charging cable is carried by several cable carriers that are attached to the guiding device.

The cable guide system according to the invention with the ceiling-mounted arrangement allows unrestricted movement space for all electric vehicles on the floor side. The charging plug can be hung at a height that avoids any collision with the electric vehicle. The charging plug should be moved by the movement of the deflection unit. It is moved automatically when the deflection unit is actively shifted.

The vertical deflection station in the cable guide system according to the invention is stationary, i.e. the charging cable can be moved vertically downwards only at this one point. However, due to the U-shaped course of the charging cable, a very long charging cable can be used with comparatively little effort for the cable guide system. The U-shaped arrangement with two parallel legs of the charging cable halves the space requirement compared to the extended length of the charging cable. The larger the cross-section of the charging cable, the larger the diameter of the deflection unit must be.

In a favorable further development of the invention, the cable guide system has two horizontal and parallel guide rails arranged next to one another or, alternatively, two horizontal and vertical guide rails arranged one above the other, in each of which cable carriers are slidably guided in order to carry the charging cable parallel to the guide rails. Each leg of the charging cable is therefore assigned a guide rail. The cable carriers of one leg can be moved independently of the cable carrier of the other leg. Overall, the legs should be guided in parallel by the guide rails and cable carriers.

According to a further embodiment of the invention, a drive rail is arranged between the guide rails for the legs of the U-shaped deflected charging cable. The drive rail is used to guide a tappet in the drive rail, wherein the tappet holds and guides the deflection unit. Due to the stationary vertical deflection station, the deflection unit must inevitably change its position if the charging plug is to be lowered. The change in position is carried out via the tappet in the drive rail. The tappet is a guide carriage that is mounted in the drive rail and connected to a linear drive system. The linear drive system can have a traction drive in which the traction means (belt, chain) is arranged in the drive rail. A tappet drive is arranged at the end of the drive rail. The tappet drive, the drive rail with the traction drive and the tappet as well as a control for the tappet drive form the linear drive system.

The deflection unit is used to form the U-shaped bend of the charging cable. Preferably, the deflection unit is also held on at least one guide rail for the legs of the U-shaped deflected charging cable and is guided and displaced accordingly in the longitudinal direction. The U-shaped bend, i.e. the deflection area, also preferably runs in the same plane as the two legs of the deflected charging cable. For deflection, the deflection unit preferably has several roller guides. The roller guides are arranged in an arch, for example at an angular distance of 45°, and describe an arched deflection path. For this purpose, the deflection unit has a frame to which the roller guides are attached. The frame can also be arched. Preferably the frame spans across 180°. The frame can be formed from an arched support plate. The ends of the support plate or frame can be attached to the guide rails for the legs of the deflected charging cable, while the middle of the support plate is guided and held on the central guide rail. This three-point bearing prevents tilting and allows for exact parallel guidance of the deflection unit along the guide rails.

Alternatively, the deflection can also be carried out via plain bearing systems or a combination of plain bearings and roller bushings.

All guide rails are preferably connected to each other via a supporting structure. These can be individual crossbars, arranged at intervals and attached to a ceiling or supporting structure. Advantageously, the vertical deflection station is also fixed to one of the guide rails. This also holds the vertical deflection station above the support structure. The cable guide system according to the invention has only relatively few connection points with the existing building structure and is therefore easy to install and retrofit.

According to an advantageous development of the invention, the vertical deflection station also has a roller guide between its horizontally open inlet end for the charging cable and its downwardly open outlet end for the charging cable. The outlet end is preferably directed vertically downwards and leads to the end that carries the charging plug. Inside the vertical deflection station, one or more roller guides can also be arranged in an arched arrangement to minimize frictional resistance when lowering the charging plug. Alternatively or in addition to a roller guide, a plain bearing system can be provided for deflection.

The cable guide system is designed to automatically lower and raise the charging plug. When the charging plug is not in use, it can be arranged in a predetermined starting position. In particular, this is a raised position so that a vehicle to be charged does not collide with the charging plug during maneuvering. To raise the charging plug when not in use, the deflection unit is moved so that the distance to the vertical deflection unit is increased, causing the charging cable to retract. The deflection unit is moved via the tappet, which is moved linearly along the drive rail. The tappet is shifted via the tappet drive, comparable to a ceiling-mounted garage door drive for sectional doors. The charging cable with the charging plug can also be lowered again using said tappet drive. It is therefore a cable routing system with an electric motor drive for raising and lowering the charging plug.

The system described can be supported by a spring force. When retracting the charging plug, a spring force can be built up by tensioning a spring through the movement of the cable routing system. When the charging plug is to be lowered again, the built-up spring force acts in the direction of the charging plug and pushes it downwards. After the previously built-up spring force has been reduced again, e.g. by relaxing a spring, the weight of the charging cable and the plug is sufficient to move the charging plug further downwards. It is moved by its weight, i.e. pulled and not pushed. This relieves the load on the deflection unit and the linear drive system.

The spring can be configured as a coil spring and surround the charging cable. It protects the charging cable from kinks. It can be effective between a bottom side of the vertical deflection unit and a top side of the charging plug, or it can be supported on corresponding contact surfaces. The effect of the spring is always to support the charging plug when lowering. The friction and deformation work of the charging cable within the guiding device must be overcome. Rolling resistances must be overcome in the area of the guide rails and the roller guide. Furthermore, the charging cable must be bent in the area of the deflection unit. In addition, there is a relative movement between the cable carriers and the charging cable. For this purpose, the cable carriers advantageously have sliding sleeves through which the charging cable is guided. The sliding sleeves preferably have a low frictional resistance so that the spring only has to generate a small force to move the charging plug out of its initial position. This also means that the charging plug can be pulled up again with relatively little force.

The cable carriers do not necessarily have to have sliding sleeves. The aim is to allow for low-resistance guidance. For example, roller windows can be used on the cable carriers.

The cable guide system according to the invention provides that the legs of the charging cable are always arranged substantially parallel to the guide rails and are free from hanging loops. This ensures a low installation height. The cable carriers are positioned at defined intervals on the guide rails. They can be connected to each other via drag elements. The drag elements create a connection between the cable carriers and ensure that the distance does not become too large. The drag elements allow the distance between the cable carriers to be reduced. If sliding sleeves are used instead of roller windows, they have a certain length in the longitudinal direction of the charging cables, so that there is line contact within the sliding sleeves and not a very narrow point contact. The length of the sliding sleeves is designed to minimize the tendency of the charging cable to form loops.

Insofar as it is stated within the scope of the invention that the legs of the charging cable are always essentially arranged parallel to the guide rails, the term “essentially parallel” takes into account that, due to the inevitable play of the charging cable within the sliding sleeves, as well as due to temperature differences and wear and tear as well as material fatigue, it is not technically possible to guide the charging cables perfectly parallel. However, from a functional point of view, the charging cables should always only have a slight downward deflection due to gravity, i.e. they should not form any loops.

In the following, the invention will be described in greater detail with reference to exemplary embodiments illustrated in the schematic drawings. In particular:

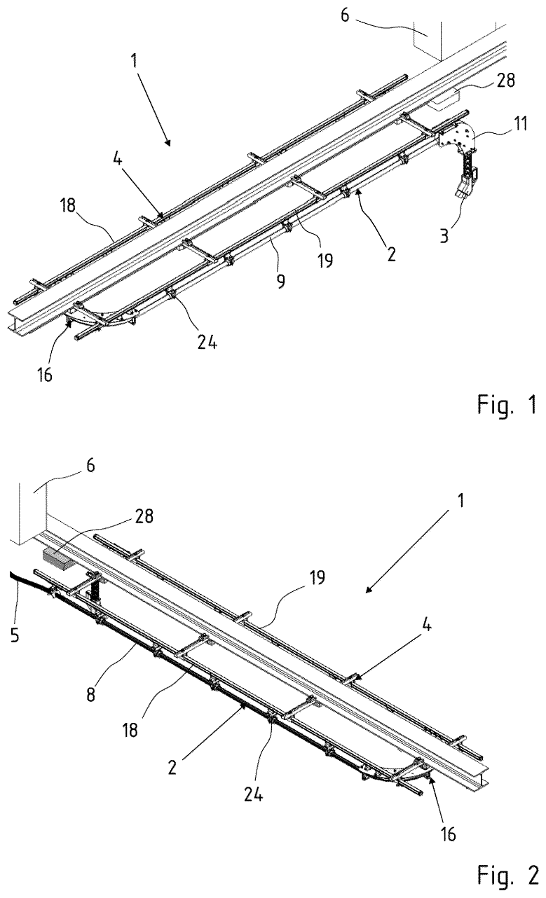

FIG. 1 is a perspective view of a cable guide system from an angle above;

FIG. 2 is a perspective view of the cable guide system of FIG. 2, also from an angle above;

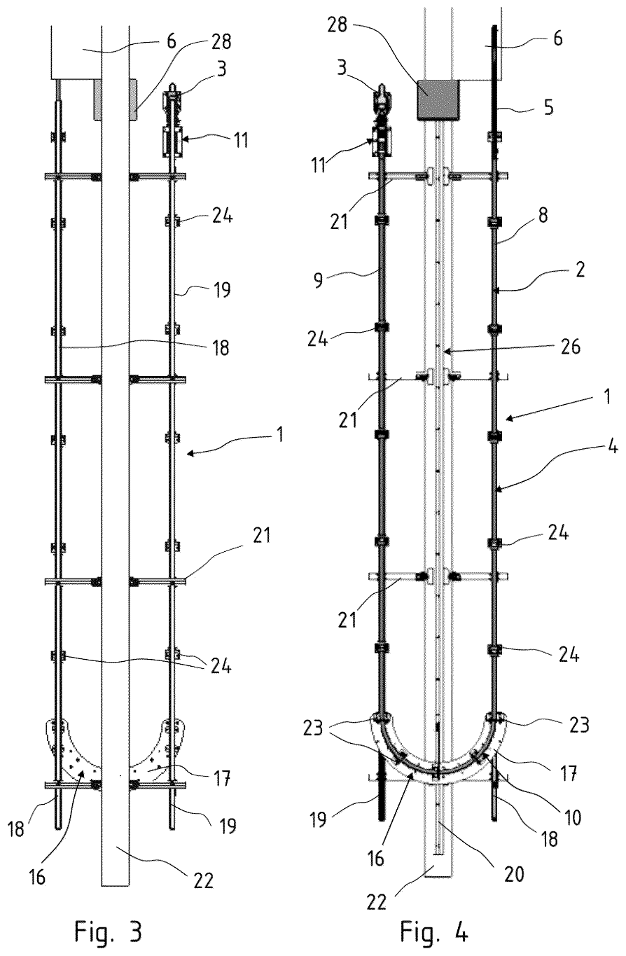

FIG. 3 is a vertical top view of the cable guide system of FIGS. 1 and 2;

FIG. 4 is a view from below of the cable guide system of the previous figures;

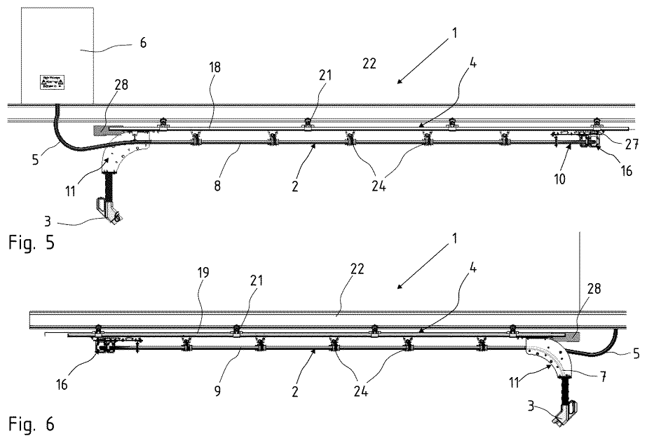

FIG. 5 is a side view of the cable guide system of FIGS. 1 to 4;

FIG. 6 is another side view of the cable guide system of FIG. 1 up to 5;

FIG. 7 is a perspective view from an angle below of the deflection unit of the cable guide system of FIGS. 1 to 6;

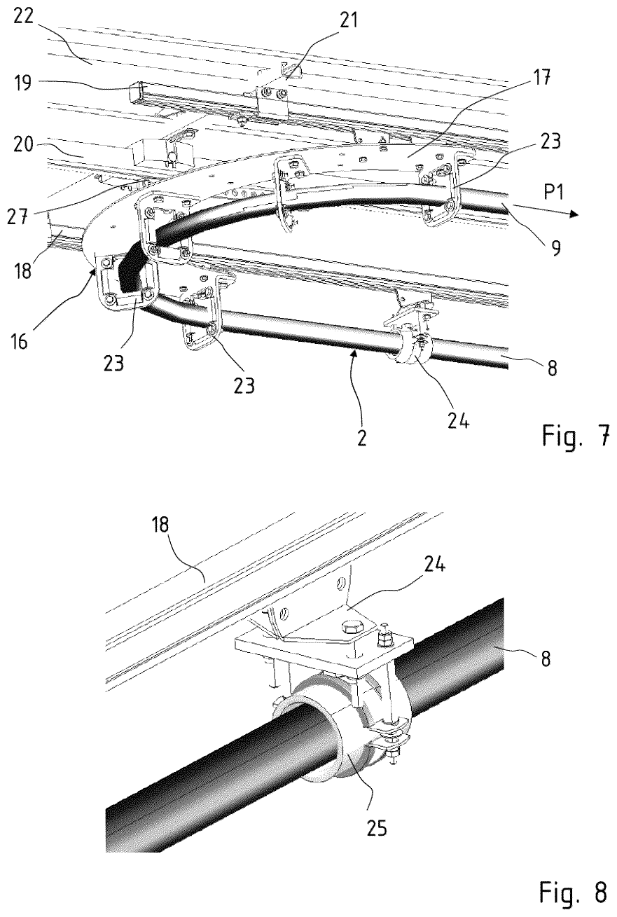

FIG. 8 is in perspective view a cable carrier of the cable guide system;

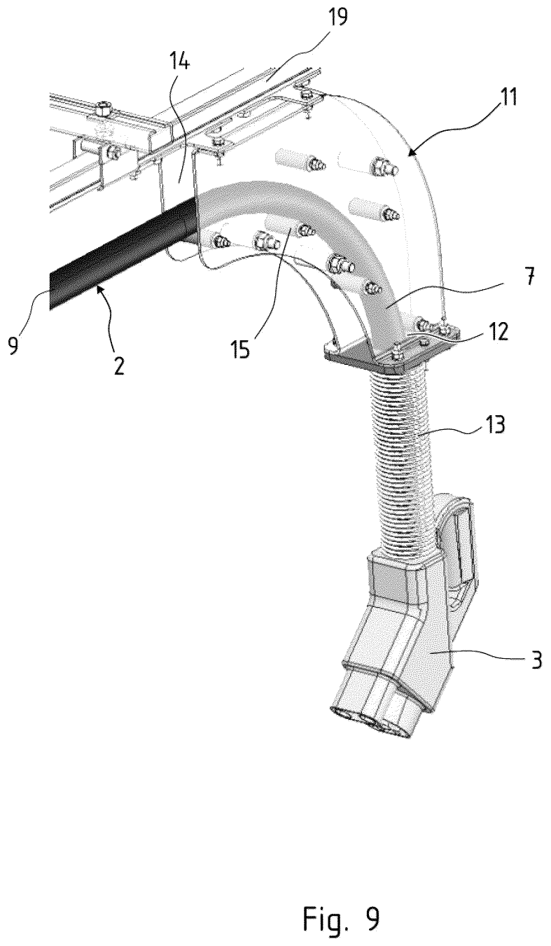

FIG. 9 is a perspective view of a vertical deflection station;

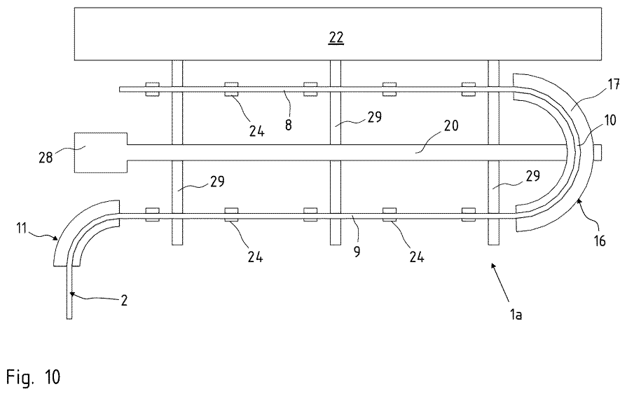

FIG. 10 is a simplified representation of a cable guide system according to a second embodiment.

FIGS. 1 to 9 all refer to the same exemplary embodiment of a cable guide system with legs arranged horizontally next to one another, wherein the exemplary embodiment is shown in FIGS. 1 and 2 from two perspectives from an angle above and in FIGS. 3 to 6 from vertically above and below and from the left and right side, respectively. FIGS. 7 to 9 show details in perspective view.

FIG. 10 shows a schematic diagram of a second exemplary embodiment of a cable guide system with legs arranged vertically one above the other, whereby the reference signs introduced for the exemplary embodiment of FIGS. 1 to 9 are also used for components of the second exemplary embodiment that have the same function.

The cable guide system 1 is used to charge an electric vehicle (not shown in detail) and comprises a charging cable 2 with a charging plug 3 at the end. The charging cable 2 is held in a U-shape on a guiding device 4. The guiding device 4 supports the charging cable 2 in its longitudinal course from a connection end 5 at a stationary supply station 6 (FIG. 5) to the end 7 of the charging cable 2 to which the charging plug 3 is attached.

From illustrations 5 and 6 it can be seen that the two parallel legs 8, 9 of the charging cable connected to the U-shaped deflection area 10 of the charging cable are arranged horizontally next to one another. The U-shaped deflection area 10 of the charging cable is also located in the same horizontal plane as the legs 8, 9 of the charging cable 2 on both sides.

The entire cable guide system 1 and, in particular, the guiding device 4 are arranged in a suspended manner so that the charging cable 2 can be lowered from above by moving the charging plug 3, which is suspended downwards, downwards. For this purpose, the end 7 of the charging cable 2 is located in a stationary vertical deflection station 11. The charging cable 2 is introduced into the vertical deflection station 11 in the aforementioned horizontal plane and guided vertically downwards, i.e. after being deflected 900 out of the vertical deflection station 11, it is guided out of the latter.

FIGS. 5, 6 and 9 show that the charging plug 3 is arranged at a vertical distance from the vertical deflection station 11. A spring 13 is located between an outlet end 12 of the vertical deflection station 11 for the charging cable 2, which is open at the bottom, and the charging plug 3. It is configured as a pressure spring to press the charging plug 3 downwards. The spring 13 surrounds the charging cable 2. When the charging plug 3 is lowered, the charging cable 2 is pressed into the vertical deflection station 11 via a horizontally open inlet end 14 of the vertical deflection station 11, wherein it is guided to the outlet end 12 via a roller guide 15 of the vertical deflection station 11 with the least possible resistance. This releases the tension on spring 13. When the spring 13 is completely relaxed again when the charging plug 2 is lowered, the weight of the downward-hanging plug-side end 7 of the charging cable 2 and that of the charging plug 3 is large enough for further lowering. Support by means of spring force can be dispensed with in the 2nd phase of lowering.

The cable guide system comprises a deflection unit 16. It is configured in an arc and extends from leg 8 to leg 9 of the charging cable 2. From the perspective view of FIG. 7, it can be seen that the deflection unit 16 has an arched support plate 17, on the underside of which a plurality of roller guides 23 is arranged. In this embodiment, a total of five roller guides 23 are arranged distributed over an angular range of 180°. The included angle between two roller guides is 23 45° in each case. The roller guides 23 each have guide rollers for the charging cable 2 on three sides and thus determine the deflection area 10 of the charging cable 2.

The deflection unit 16 is intended to exert a deflection force on the charging cable 2. For this purpose, the deflection unit 16 is moved via a linear drive system 26 in the direction of the vertical deflection station 11, or the distance to the vertical deflection station 11 is increased. The linear drive system 26 functions according to the principle of a garage drive and comprises a drive rail 20, a traction means arranged in the drive rail 20, which can be, for example, a belt, a chain or generally a wrapping means. A tappet 27 is connected to the traction means, whereby the traction means is moved via a tappet drive 28. The tappet drive 28 is arranged at the end of the drive rail 20. When the tappet drive 28 is switched on, the traction means is moved and the tappet 27 connected to the traction means is displaced in the longitudinal direction of the drive rail 20. It is mounted in the drive rail 20 and connected to the deflection unit 16. To lower the charging plug 3, the tappet 27 of the linear drive system 26 is shifted linearly in the direction of the vertical deflection station 11. The deflection unit 16 is dragged along. Within the five roller guides 23, the charging cable 2 is initially deflected by the support of the spring 13 in such a way that the two legs 8, 9 of the charging cable 2 are shortened evenly, thereby freeing up cable length that is available at the plug-side end 7. The retraction is activated by shifting the tappet 27 in the opposite direction.

The support plate 17 of the deflection unit 16 is guided and supported by guide rails 18, 19 above the legs 8, 9. The drive rail 20 of the linear drive system 26 is located centrally between the two parallel guide rails 18, 19 for the legs 8, 9. FIG. 4 shows that the guide rails 18, 19 and the drive rail 20 are connected to one another via horizontal struts 21. Above the horizontal struts 21, of which several are arranged in the longitudinal direction of the guide rails 18, 19, and which run transversely to the guide rails 18, 19, a lattice frame structure or ladder-like structure is created, which as such is arranged below a horizontal beam 22. In this case, the horizontal beam 22 is a double-T beam. The cable guide system 1 is located below this double-T beam. The double-T beam or the horizontal beam 22 can, for example, be part of a supporting structure of a building or can also be mounted to arrange the cable guide system. The guide rails 18, 19 for the legs 8, 9 are preferably located at the same horizontal distance from the horizontal beam, which is arranged in the area of the central longitudinal axis of the system, so that the cable guide system is in balance over a large part of its length.

The schematic representations make it clear that neither the width of the deflection area 10 nor the longitudinal extent of the cable guide system 1 measured in the length of the guide rails 18, 19 is to be limited to the proportions shown. Of course, longer charging cables 2 can also be guided and held by longer guide rails 18, 19, if necessary.

By way of example, in this embodiment only the supply station 6 (FIG. 5) is located above the horizontal beam 22. As a result, a maximum clearance height is available below the horizontal beam 22, which is only limited in the area of the charging plug 3 oriented downward. The cable guide system 1 according to the invention can therefore be approached from all sides. It is not necessary for the cable guide system 1 to be arranged parallel to the parking direction of the electric vehicles. The cable guide system 1 can also be positioned transversely to the parking direction of the electric vehicles.

The charging cable 2 can be released until both legs 8, 9 have been shortened to the maximum, i.e. until the point at which the deflection unit 16 can no longer be shifted. For this purpose, one or more of the guide rails can have 18, 19 limiters arranged; preferably, limit switches are provided that switch off the tappet drive when the end positions are reached.

The figures show that charging cable 2 always runs horizontally, even when retracted, and that no hanging loops are formed. The legs 8, 9 of the charging cable 2 are always essentially arranged parallel to the guide rails 18, 19 above them and also arranged parallel to each other.

To prevent charging cable 2 from forming hanging loops, several cable carriers 24 are arranged below guide rails 18, 19. The cable carriers 24 are slidable in the longitudinal direction of the guide rails 18, 19. In this case, they also have sliding sleeves 25 through which the charging cable 2 is guided. The sliding sleeves 25 have a certain length so that the charging cable 2 is in contact with the sliding sleeves 25 not in point contact but in line contact. The sliding sleeves 25 can, for example, consist of a PTFE material or have a corresponding coating which has a low coefficient of friction with the sheath of the charging cable 2. When lowering the charging plug 3, the deflection unit 16 is first moved by a motor in the longitudinal direction of the guide rails 18, 19 and the drive rail 20 until the deflection unit 16 hits the first cable carriers 24. These first cable carriers 24 are now pushed together by the deflection unit 16 until they meet the other adjacent cable carriers 24 until the final position is finally reached.

When returning to the starting position, the cable carriers 24 return to their original position one after the other. For this purpose, they are connected to one another via drag elements in a manner not shown in detail, so that a maximum distance between the cable carriers 24 cannot be exceeded. As a result, the legs 8, 9 of the charging cable 2 always remain essentially parallel to the guide rails 18, 19 without forming hanging loops.

FIG. 10 shows a second embodiment of a cable guide system 1a, in which the legs 8, 9 are not arranged horizontally next to one another, but vertically one above the other. The deflection area 10 of the charging cable 2 therefore runs in a vertical plane. The vertical plane corresponds to the image plane of FIG. 10. The deflection unit 16 is also vertically oriented. The two legs 8, 9 are supported on cable carriers 24, which are guided in guide rails not shown in detail. The entire system is suspended from a horizontal beam 22. Several vertical struts 29 carry the cable guide system 1a over the guide rails (not shown in more detail) and the drive rail 20 with the tappet drive 28. For a description of how it works, refer to the explanations in FIGS. 1 to 9.

### REFERENCE NUMERALS

1—cable guide system
1a—cable guide system
2—charging cable
3—charging plug
4—guiding device
5—connection end of 2
6—supply station
7—plug-side end of 2
8—leg of 2
9—leg of 2
10—deflection area of 2
11—vertical deflection station
12—outlet end of 11
13—spring
14—inlet end of 11
15—roller guide in 11
16—deflection unit
17—support plate of 16
18—guide rail for 8
19—guide rail for 9
20—drive rail
21—horizontal strut
22—horizontal beam
23—roller guide of 16
24—cable carrier
25—sliding sleeves
26—linear drive system
27—tappet
28—tappet drive
29—vertical strut
P1—arrow=direction of movement of 9

1. A cable guiding system (1, 1a) for charging an electric vehicle, comprising a charging cable (2) with a charging plug (3) at one end, wherein the charging cable (2) is guided in a U-shape in its course from a connection end to its end with the charging plug (3) in a guiding device (4), so that the charging cable (2) in a U-shape has two legs (8, 9) next to one another, wherein the end of the charging cable (2) carrying the charging plug (3) is deflected downwards in a stationary vertical deflection station (11), so that the charging plug (3) is arranged hanging below the vertical deflection station (11), wherein the guiding device (4) has a deflection unit (16) for U-shaped deflection, which can be displaced in a longitudinal direction of the guiding device (4) and wherein the charging cable (2) is carried and guided by several cable carriers (24) between its connecting end (5) and the deflection unit (16) as well as between the deflection unit (16) and the vertical deflection station (11).

2. The cable guide system (1, 1a) of claim 1, wherein the deflection unit (16) is connected to a linear drive system (26) in order to displace the deflection unit (16) for lowering and raising the charging plug (3).

3. The cable guide system (1, 1a) of claim 2, wherein the linear drive system (26) has a drive rail (20), a tappet (27) linearly guided in the drive rail (20) and a tappet drive (28) for displacing the tappet (27) in the drive rail (20), wherein the tappet (27) is connected to the deflection unit (16).

4. The cable guide system (1, 1a) of claim 1, wherein the guiding device (4) has two guide rails (18, 19) arranged parallel to one another, in each of which cable carriers (24) are guided in order to carry and guide the charging cable (2) parallel to the guide rails (18, 19).

5. The cable guide system (1, 1a) of claim 3, wherein the drive rail (20) is arranged between the guide rails (18, 19) for the legs (8, 9) of the U-shaped deflected charging cable (2).

6. The cable guide system (1, 1a) of claim 1, wherein the deflection unit (16) is held on the guide rails (18, 19) for the legs (8, 9) of the U-shaped deflected charging cable (2) and is displaceable in the longitudinal direction of these guide rails (18, 19).

7. The cable guide system (1, 1a) of claim 1, wherein the deflection unit (16) has several roller guides (23) for the charging cable (2), wherein the roller guides (23) are arranged in an arc.

8. The cable guide system (1, 1a) of claim 1, wherein the vertical deflection station (11) has a roller guide (15) between its horizontally open inlet end (14) for the charging cable (2) and its downwardly open outlet end (12) for the charging cable (2).

9. The cable guide system (1, 1a) of claim 8, wherein a spring (13) is arranged between the vertical deflection station (11) and the charging plug (3) in order to prestress the charging cable (2) when the charging plug (3) is raised and to assist in lowering the charging plug (3).

10. The cable guide system (1, 1a) of claim 1, wherein cable carriers (24) have sliding sleeves (25) or roller windows through which the charging cable (2) is guided.

11. The cable guide system (1, 1a) of claim 1, wherein the legs (8, 9) of the charging cable (2) are always arranged substantially parallel to the guide rails (18, 19) and are free from hanging loops.

12. The cable guide system (1, 1a) of claim 1, wherein the cable carriers (24) are connected to one another via drag elements in order to set a defined distance.
